(19) United States
(12) Patent Application Publication
(10) Pub. No.: US 2026/0124692 A1
(43) Pub. Date: May 7, 2026

(54) MOBILE CLOSE PROXIMITY ORBITAL WELDING SYSTEM HAVING A SHIELDED WELD ZONE

(71) Applicant: Valex. Corp., Ventura, CA (US)

(72) Inventors: Claudiu C. Caldarescu, Thousand Oaks, CA (US); Huabin Weng, Yorba Linda, CA (US); Cosmo C. Mao, Newbury Park, CA (US); Dillon Silver, Oxnard, CA (US)

(73) Assignee: Valex. Corp., Ventura, CA (US)

(21) Appl. No.: 19/381,225

(22) Filed: Nov. 6, 2025

Related U.S. Application Data
(60) Provisional application No. 63/717,553, filed on Nov. 7, 2024.

(51) Int. Cl. B23K 9/028; B23K 9/167; B23K 9/32; B23K 35/22; B23K 37/02; B23K 37/0533; B23K 101/06

(52) U.S. Cl. CPC B23K 9/0286; B23K 9/167; B23K 9/326; B23K 35/222; B23K 37/0276; B23K 37/0282; B23K 37/0533; B23K 2101/06

(57) ABSTRACT

An orbital welding system is disclosed for joining a riser to a pulled collar on a manifold runner with a circumferential weld bead, which includes a multi-axis welding platform, a weld head assembly supported on the welding platform and including a shaft housing, an electrode drive shaft mounted for axial rotation within the shaft housing, a drive motor connected to the electrode drive shaft for axially rotating the electrode drive shaft, and a torch assembly that rotates with the electrode drive shaft and includes a vertical torch shaft having an electrode holder at an upper end thereof for retaining a tungsten electrode.

### CROSS-REFERENCE TO RELATED APPLICATIONS

This application claims the benefit of priority to U.S. Provisional Patent Application No. 63/717,533, filed Nov. 7, 2024, the disclosure of which is incorporated herein by reference in its entirety.

### BACKGROUND OF THE INVENTION

### 1. Field of the Invention

The subject invention is directed to a mobile welding system and method for producing repeatable high-quality orbital butt-welds in tight weld area locations, and more particularly, to a mobile close-proximity orbital welding system for joining a pipe or tube riser to a pulled collar on a manifold runner pipe or tube utilizing gas tungsten arc welding (GTAW), wherein the heat-affected weld zone is shielded from atmospheric contamination.

### 2. Description of Related Art

Orbital welding systems for joining thin-walled steel pipes or tubes to one another along a circumferential weld joint are well known in the art. Such welding systems are typically automated and include a programmable solid-state power supply and a welding electrode supported on a motorized orbital weld head. The programable power supply controls the welding parameters of the system, including the arc welding current and the power to drive the motor that rotates the weld head.

Orbital welding systems typically use a Gas Tungsten Arc Welding (GTAW) process that uses a non-consumable tungsten electrode to generate an electric arc that melts the steel base material and forms the weld. The orbital weld head rotates the tungsten electrode around the circumferential weld joint to join adjacent pipe or tube surfaces. Orbital weld heads are usually enclosed within an inert atmospheric chamber that surrounds the weld joint. An inert shielding gas, such as argon, is fed into the chamber to protect the weld from atmospheric contamination.

Orbital welding systems can outperform manual welding systems both qualitatively and quantitatively and consistently yield a higher quality of weld without the variability, inconsistencies, errors, or defects associated with manual welding. And thus, there exists a need in the art for an orbital welding system that is designed to join a pipe or tube riser to a pulled collar on a manifold pipe or tube runner in an efficient and repeatable manner, within tight weld area locations. Moreover, a mobile orbital welding system that can be easily transported within a manufacturing facility would be highly desirable. The subject invention provides such a welding system.

### SUMMARY OF THE DISCLOSURE

The subject disclosure is directed to a new and useful orbital welding system and method for producing repeatable high-quality orbital butt-welds in tight weld area locations, and more particularly, to a mobile close-proximity orbital welding system and method for joining a tubular riser to a pulled collar on a manifold runner with a circumferential weld bead, utilizing gas tungsten arc welding (GTAW).

The orbital welding system of the subject disclosure includes a multi-axis welding platform having a base plate defining a horizontal plane, a lift plate adjustable along a vertical axis relative to the base plate, a lower slide plate adjustable within a first horizontal plane relative to the lift plate along a first horizontal axis, an upper slide plate adjustable within a second horizontal plane relative to the lower slide plate along a second horizontal axis that is perpendicular to the first horizontal axis, and a tilt stage assembly including a lower tilt plate defining a third horizontal plane and an upper tilt plate that is adjustable within a tilt plane relative to the lower tilt plate.

The orbital welding system further includes a weld head assembly that is supported on the upper tilt plate of the tilt stage assembly of the multi-axis welding platform and includes a shaft housing, an elongated radially outer electrode drive shaft mounted for axial rotation within the shaft housing, a drive motor operatively connected to the electrode drive shaft for axially rotating the electrode drive shaft relative to the shaft housing, and an elongated non-rotating radially inner insulated support shaft extending coaxially through an axial bore of the outer drive shaft.

The orbital welding also includes a torch assembly having a dual-axis slide mechanism that is coupled to an upper end portion of the electrode drive shaft so that the torch assembly rotates coaxially with the electrode drive shaft, an elongated vertical torch shaft extending from the dual-axis side mechanism, and an electrode holder connected to an upper end portion of the vertical torch shaft for retaining a tungsten electrode.

The orbital welding system further includes a mobile transport cart having a rectangular structural frame and defining an upper staging area for supporting the base plate multi-axis welding platform. The mobile transport cart further includes a plurality of castor assemblies each including a swiveling support bracket mounted to the structural frame, a rotatable castor wheel mounted to the bracket, a pivoting wheel lock lever for securing the position of the castor wheel to keep the transport cart stationary during operation and a stabilizing foot having high and low fixed positions for maintaining the transport cart in a level condition during welding.

Preferably, a linear actuator extends through an aperture in the base plate of the multi-axis welding platform, and it is operatively connected to a bottom surface of the lift plate for moving the lift plate along the vertical axis relative to the base plate. A plurality of vertical riser legs extend upwardly through respective apertures in the base plate and an upper end of each riser leg is fastened to a bottom surface of the lift plate to vertically support the lift plate. A clamping collar is operatively associated with each riser leg for securing the vertical position of each riser leg relative to the base plate. A manually operated joystick is operatively associated with the welding platform for controlling the linear actuator.

In a preferred embodiment of the subject disclosure, a first manually adjustable horizontal drive screw is operatively associated with the lower slide plate for moving the lower slide plate within the first horizontal plane relative to the lift plate, and a second manually adjustable horizontal drive screw is operatively associated with the upper slide plate for moving the upper slide plate within the second horizontal plane relative to the lower slide plate lift plate. Preferably, a plurality of manually adjustable vertical leveling rods is operatively associated with the tilt stage assembly for angularly moving the upper tilt stage plate within the tilt plane relative to the lower tilt stage plate.

In a preferred embodiment of the subject disclosure, a drive gear is coaxially mounted to the electrode drive shaft by a slip ring, and the drive gear is operatively connected to a servo motor by a spur gear assembly housed in a gear box. A limit switch is preferably associated with the drive gear and/or the slip ring for detecting the rotational position of the drive gear and/or the slip ring, to detect when the weld head returns to its home position after each weld cycle.

Preferably, a bearing housing is operatively connected to an end upper portion of the outer drive shaft by a threaded set screw, and a ring bearing is seated in the bearing housing to accommodate axial rotation of the outer drive shaft relative to the non-rotating inner support shaft. An upper end portion of the non-rotating shaft extends above the bearing housing, and it defines a fixturing connection for accommodating one or more spacers and/or the riser.

Preferably, the dual axis slide mechanism is coupled to the upper end portion of the outer drive shaft below the bearing housing so that the torch assembly rotates coaxially with the electrode drive shaft and the bearing housing relative to the inner support shaft. The dual axis slide mechanism includes a slide flange that is slidably mounted on a pair of horizontal slide rods, and the slide flange has a central flange portion with a vertical bore for accommodating the vertical torch shaft. The slide flange is adapted to be selectively positioned and retained along the length of the slide rods in a desired horizontal position, and it is configured for selectively retaining the torch shaft in a desired vertical position.

Preferably, the electrode holder is pivotably connected to an upper end portion of the vertical torch shaft and it is configured for angular adjustment about a horizontal pivot axis extending perpendicular to the torch shaft. A set screw is provided for securing the tungsten electrode within a retaining bore formed in the electrode holder.

An axial bore extends through the non-rotating support shaft to define a path for the ingress and egress of purge gas from an interior of the manifold runner, and the axial bore of the support shaft communicates with a purge outlet located below the upper tilt plate. A lower end portion of the outer drive shaft is supported for rotation by a ring bearing seated in the upper tilt plate.

The orbital welding system further includes a weld shield assembly that is configured to enclose the torch assembly to define a shielded chamber or welding zone for receiving an inert gas that protects a weld from atmospheric contamination. The weld shield assembly is preferably constructed from a pair of opposed rectangular shield sections that are releasably secured to one another by one or more locking clasps or latches. Once latched together, the weld shield assembly is held in place by the manifold runner. One or both shield sections may include a viewing window with a weld glass for observing a welding process. Preferably, a gas or oxygen analyzer is provided for monitoring purge gas purity by taking readings at the weld shield assembly.

In an embodiment of the subject disclosure, the weld shield assembly has opposed lateral side walls each having a circular portal for accommodating passage of the manifold runner, and the circular portals are horizontally aligned and configured to receive runner insert rings of differing size for accommodating runners of varying outer diameter.

Preferably, a programmable solid state power supply unit supported on the mobile transport cart adjacent the multi-axis welding platform for controlling welding parameters of the system and delivering power to the weld head assembly. The mobile transport cart also includes an instrument panel containing a flow meter and associated regulating valve for monitoring and regulating gas flow to and from the weld shield assembly, a flow meter and associated regulating valve for monitoring and regulating gas flow to and from the manifold runner, and a magnehelic gauge and associated regulating valve for monitoring and regulating differential pressure across a weld surface between the riser and the pulled collar of the manifold runner. Preferably, the mobile transport cart also carries a filter housing that is supported behind the instrument panel to accommodate a filter for removing particles and moisture from the purge gas before delivery to the weld shield assembly and the manifold runner.

The subject invention is also directed to a new and useful method of orbital welding, which includes the steps of axially aligning and approximating a riser with a pulled collar of a manifold runner within a shielded enclosure to define a circumferential butt seam therebetween by manually adjusting a multi-axis welding platform supporting the riser, and then positioning a tungsten electrode relative to the butt seam within the shielded enclosure.

The method further includes the steps of introducing an inert purge gas into an inner diameter of the riser and the manifold runner, and into the shielded enclosure to protect the butt seam from atmospheric contamination while welding. The method further includes the steps of orbitally welding the riser to the pulled collar along the butt seam by rotating the tungsten electrode about a central axis of the riser and then venting the inert purge gas from the manifold runner and the shielded enclosure after welding.

Preferably, the method further includes the steps of monitoring gas purity at the shieled enclosure and/or at the manifold runner, monitoring and/or regulating differential pressure across a weld surface of the butt seam, filtering the purge gas before delivery to the manifold runner and/or the shieled enclosure to remove particulates and moisture from the gas, and purifying the filtered purge gas.

These and other features of the orbital close-proximity welding system and method of the subject disclosure will become more readily apparent to those having ordinary skill in the art to which the subject invention appertains from the detailed description of the preferred embodiments taken in conjunction with the following brief description of the drawings.

### BRIEF DESCRIPTION OF THE DRAWINGS

So that those skilled in the art will readily understand how to make and use the close-proximity orbital welding system and method of the subject disclosure, preferred embodiments thereof will be described in detail herein below with reference to the figures wherein:

FIG. 1 is a perspective view of the mobile orbital welding system of the present invention, which includes a transport cart carrying a multi-axis welding platform that supports a weld head assembly, an electrical enclosure that supplies power to the weld head and a weld shield assembly that encloses the weld head assembly to define a protected weld zone, wherein a manifold runner is shown extending through and supporting the weld shield assembly;

FIG. 2 is a front elevational view of the mobile orbital welding system of FIG. 1;

FIG. 3 is a side elevational view of the mobile orbital welding system of FIG. 1;

FIG. 4 is a localized perspective view taken from FIG. 3 showing the latch for securing the weld shield together;

FIG. 5 is a localized perspective view of the mobile orbital welding system of FIG. 1, as viewed from the left side of the transport cart illustrating system components located behind the front panel of the cart, including meters to regulate gas flow to the manifold runner and weld shield and a gauge for measuring differential pressure across the weld surface;

FIG. 6 is a localized perspective view of a leveling castor assembly of the transport cart shown in FIG. 1;

FIG. 7 is a localized perspective view of a height adjustable riser leg of the multi-axis welding platform shown in FIG. 1;

FIG. 8 is an exploded perspective view of the weld head assembly supported on the multi-axis welding platform, with the weld shield separated from the torch assembly for ease of illustration, and showing a manifold riser separated from the pulled collar of the manifold runner;

FIG. 9 is a perspective view of the multi-axis welding platform with the lift plate separated from the base plate;

FIG. 10 is an exploded perspective view of the multi-axis welding platform with the slide plate assembly separated from the lift plate assembly and the tilt plate assembly;

FIG. 11 is a perspective view of the weld head assembly, with the wall of the shaft housing partially cutaway to show the drive motor and cables connected to a potentiometer located therein, and the wall of the weld shield partially cutaway to show the lower portion of the torch assembly and power cables located therein;

FIG. 12 is a perspective view of the weld head assembly with the wall of the shaft housing partially cut away to show the slip ring assembly and the limit switch assembly located therein;

FIG. 13 is an enlarged localized view taken from FIG. 12, showing the cooperation of the slip ring assembly and the limit switch assembly;

FIG. 14 is an exploded perspective view of the torch assembly with parts separated for ease of illustration;

FIG. 15 is a localized perspective view from FIG. 14 illustrating the electrode holder operatively associated with the upper end portion of the torch shaft, with a set screw for securing the tungsten electrode to the holder;

FIG. 16 is an enlarged localized view of the distal end of the tungsten electrode;

FIG. 17 is a cross-sectional view of the weld head assembly taken along line 17-17 of FIG. 12;

FIG. 18 is an enlarged localized view taken from FIG. 17 showing the gear assembly that rotates the torch assembly;

FIG. 19 is a side elevational view of the orbital welding system of the subject disclosure, with the front wall of the weld shield broken away to illustrate a close-proximity orbital welding process to join a riser to the manifold runner, wherein purge gas is delivered into the interior of the weld shield and the manifold runner supported therein;

FIG. 20 is an enlarged cross-sectional view taken along line 20-20 of FIG. 19;

FIG. 21 is an enlarged cross-sectional view taken along line 21-21 of FIG. 19, showing the riser, the fixturing supports, and the non-rotating shaft of the weld head assembly with gas from the manifold runner being purged through an axial bore of the shaft after the welding process; and

FIG. 22 is a perspective view of the orbital welding system of the subject disclosure, removed from the transport cart shown in FIG. 1, and mounted for movement along a set of linear rails of a weld stand assembly.

### DETAILED DESCRIPTION OF THE PREFERRED EMBODIMENTS

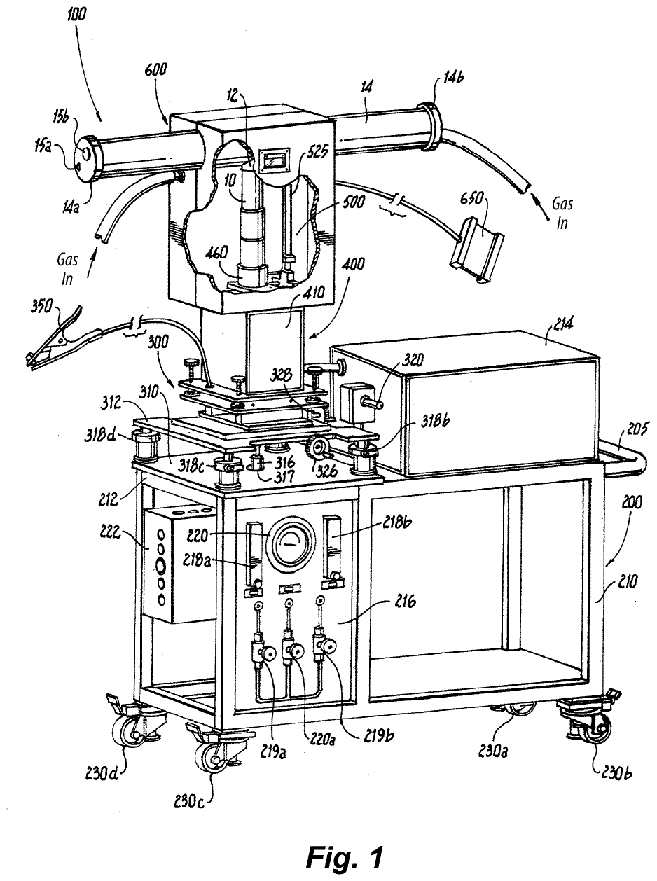

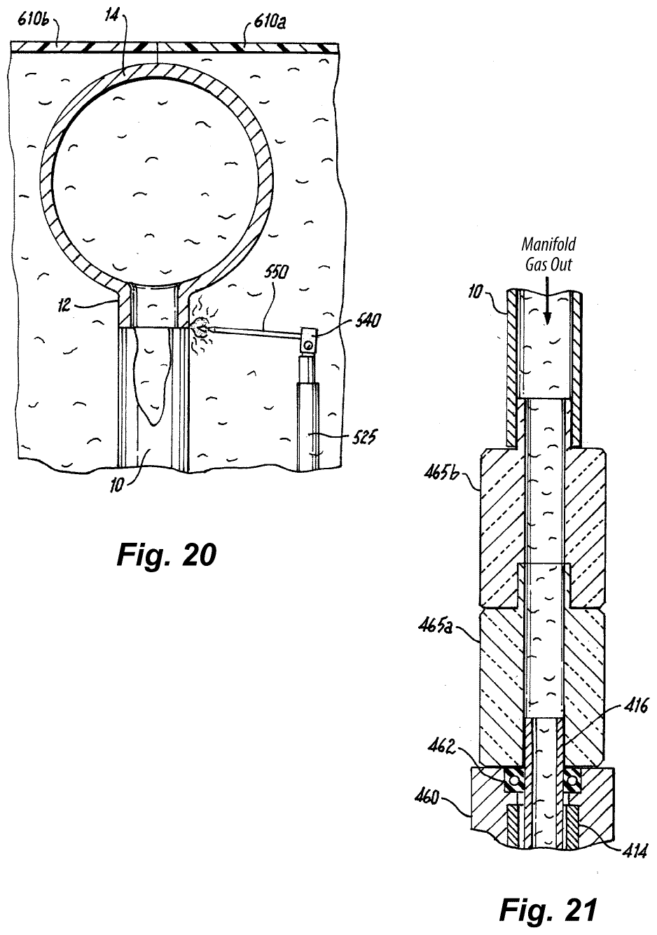

Referring now to the drawings wherein like reference numeral identify similar structural features or components of the subject disclosure, there is illustrated in FIG. 1 a new and useful mobile close-proximity orbital welding system that is designated by reference numeral 100. The orbital welding system 100 of the subject disclosure is designed to produce repeatable high-quality orbital butt-welds in tight weld areas. More particularly, the system is adapted and configured to join valves or tubes to a pulled collar formed on a tubular manifold runner by a circumferential weld bead utilizing gas tungsten arc welding (GTAW). The welding process is done within a shielded chamber containing an inert gas that protects the weld from atmospheric contamination, as shown for example in FIG. 20.

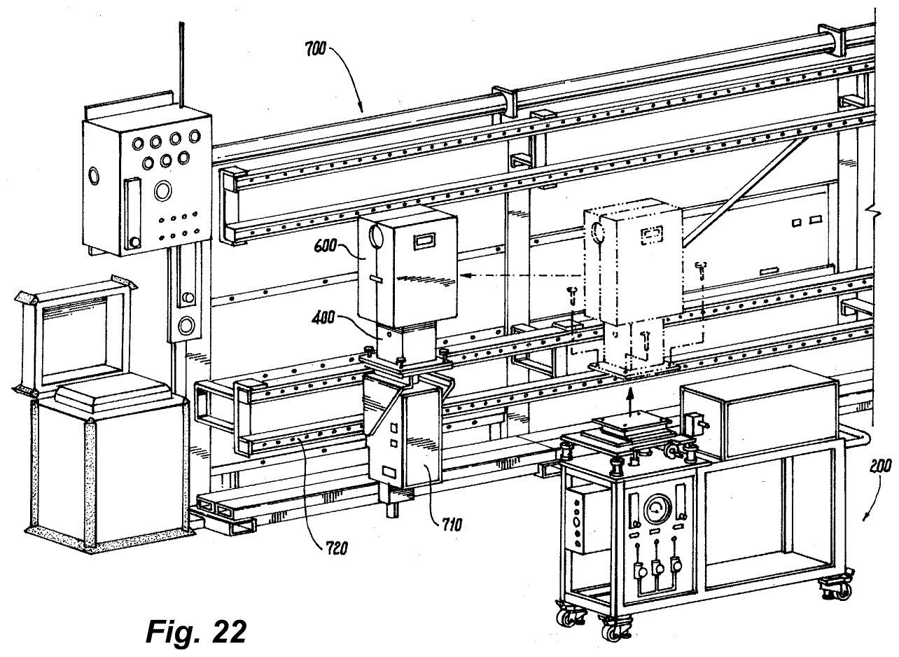

Referring now in more detail to FIG. 1, the orbital welding system 100 of the subject disclosure is shown in conjunction with a transport cart 200 that is designed to conveniently transport the welding system 100 from one location to another within a manufacturing facility or other work area. However, it is envisioned and well within the scope of the subject disclosure, that the orbital welding system 100 can be readily removed from the transport cart 200 and mounted on a separate stationary weld stand 700, as described in greater detail below with reference to FIG. 22.

The orbital welding system 100 includes a multi-axis welding platform 300 that is supported on the transport cart 200 for axially aligning and positioning a tubular riser 10 relative to an integrally formed pulled collar 12 on an elongated manifold runner 14. Manifold runners commonly range in diameter from 0.50 inches to 4.00 inches and they can vary in length from 6.00 inches to 24.00 feet. Risers commonly range in diameter from 0.25 inches to 4.00 inches and they can vary in length from 0.50 inches to 12.00 inches.

The orbital welding system 100 further includes a motorized weld head assembly 400 that is supported on the multi-axis welding platform 300, a rotating torch assembly 500 that is driven by the motorized weld head assembly 400 for orbitally welding the riser 10 to the pulled collar 12, and a weld shield assembly 600 that surrounds the torch assembly 500 and forms an enclosed heat-affected weld zone for the welding operating that is shielded from atmospheric contamination.

With continuing reference to FIGS. 1 through 3, the transport cart 200 includes a rectangular structural frame 210 that is fabricated from square steel tubing or the like. The frame 210 has a handlebar 205 at one end for an operator to steer or otherwise move the cart from one location to another. An upper staging area 212 is defined on the cart frame 210 for supporting the multi-axis welding platform 300, as well as a programmable solid state power supply unit 214 for delivering power to the weld head assembly 400. The power supply 214 controls the welding parameters of the system 100 including the power to drive the rotating torch assembly 500.

During a welding procedure, a program is selected on the welding power supply unit 214 that is typically associated by the diameter of the pulled collar and riser. The program parameters include, but are not limited to, electrode amperage, electrode rotational speed, and arc pulse time. A non-limiting example of a suitable programable power supply unit is the Model 217 WDR power supply manufactured and sold by Arc Machines, Inc. Other commercially available power supply units can be utilized.

An instrument panel 216 is provided on the front of the cart frame 210. It includes a flow meter 218a and associated regulating valve 219a for monitoring and regulating gas flow to and from the weld shield assembly 600, a flow meter 218b and associated regulating valve 219b for monitoring and regulating gas flow to and from the manifold runner 14, and a magnehelic gauge 220 and associated regulating valve 220a for monitoring and regulating differential pressure across the weld surface between the riser 10 and the pulled collar 12 of the manifold runner 14.

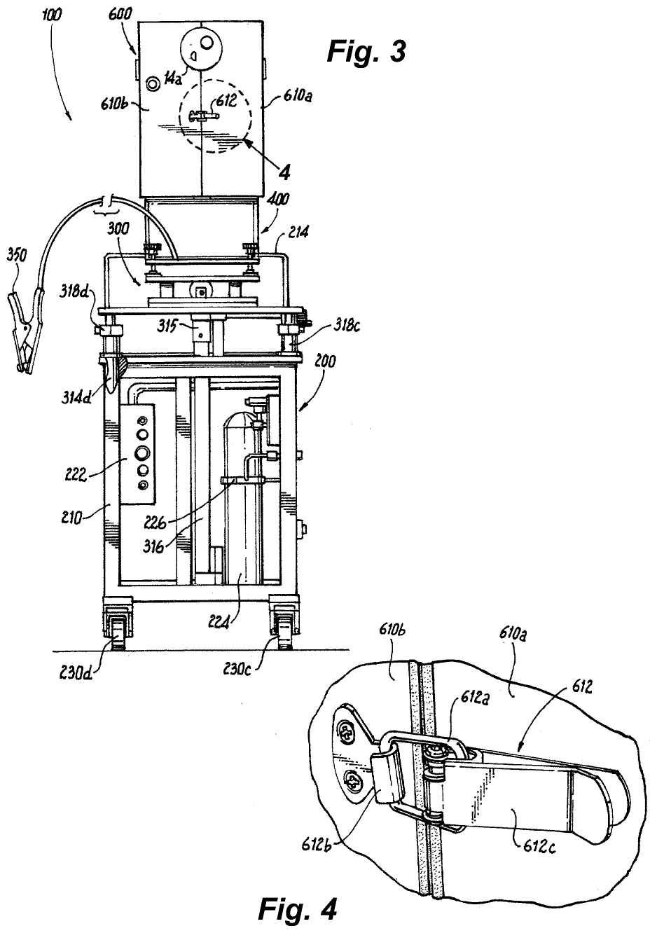

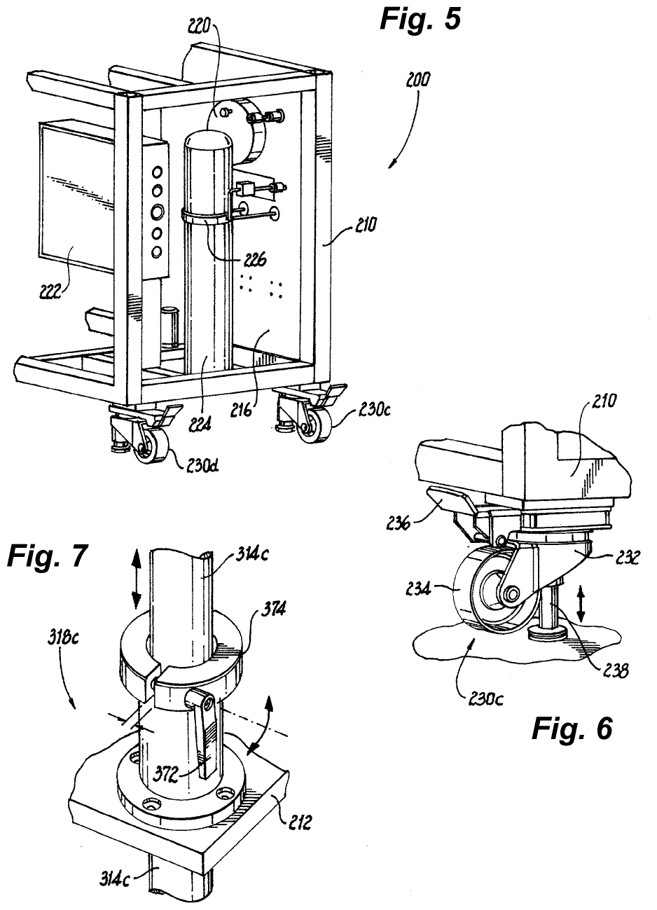

An electrical control box 222 is mounted on the rear portion of the cart frame 210 below the staging area 212 for controlling the delivery of power from the power supply 214 to the motorized weld head assembly 400 and torch assembly 500. The cart 200 carries a filter housing 224 that is supported on frame 210 behind the instrument panel 216 by a mounting bracket 226, as best seen in FIGS. 3 and 5. The filter housing 224 is adapted and configured to accommodate a filter cartridge or filter media for removing particulates and moisture from the inert purge gas flowing to the weld shield assembly 600 and manifold runner 14.

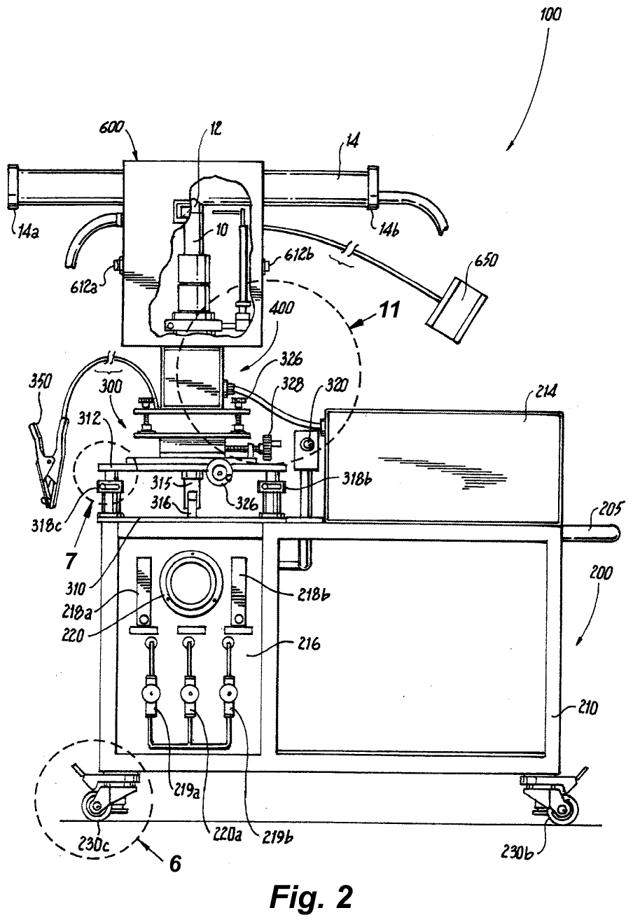

Appropriate gas conduits are provided for delivering the filtered purge gas to the manifold runner 14 and the weld shield enclosure 610a, 610b by way of the instrument panel 216, after it has passed through a dedicated purifier to ensure optimal shielding quality, as shown for example in FIGS. 1 and 2. Preferably, all gas lines and associated fittings are constructed using electropolished stainless steel tubing and UHP-rated materials to maintain ultra-high purity and minimize contamination.

The frame 210 of the transport cart 200 is equipped with four castor assemblies 230a-230d. As best seen in FIG. 6, each castor assembly 230a-230d, of which castor assembly 230c is shown, includes a swiveling support bracket 232 mounted to the structural frame 210, a rotatable castor wheel 234 mounted to the support bracket 232, a pivoting wheel lock lever 236 for securing the position of the castor wheel 234 to keep the transport cart 200 stationary during operation and a stabilizing foot 238 having high and low fixed positions for maintaining the transport cart 200 in a level condition during welding.

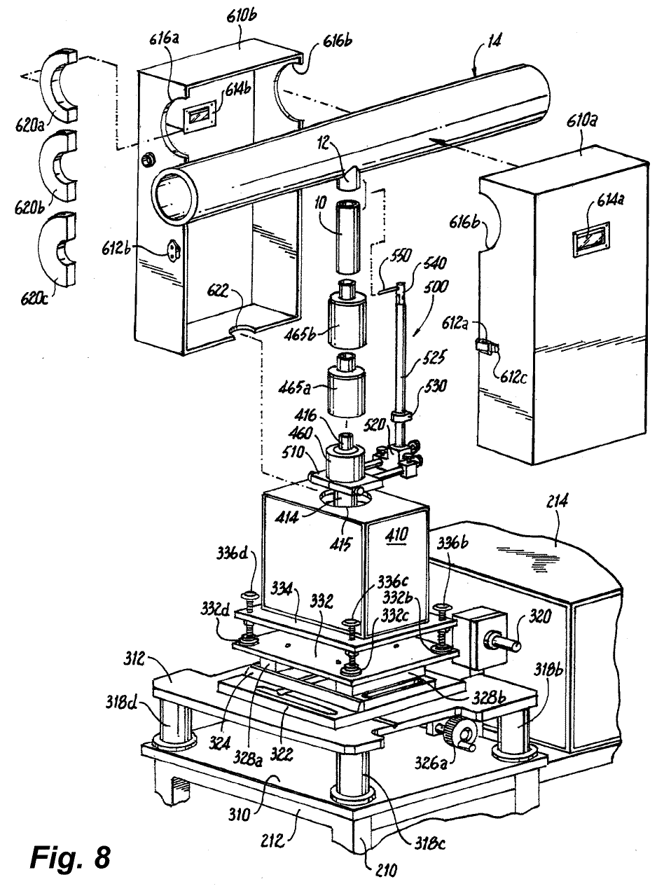

With continuing reference to FIGS. 1 through 3 in conjunction with FIGS. 8 through 10, the multi-axis welding platform 300 of the orbital welding system 100 includes a lower base plate 310 seated in the staging area 210 of cart 200 and defining a horizontal plane. The welding platform 300 further includes a lift plate 312 that is adjustable along a vertical axis (a Z-axis) relative to the base plate 310 to approximate the riser 10 with the pulled collar 12 of manifold runner 14.

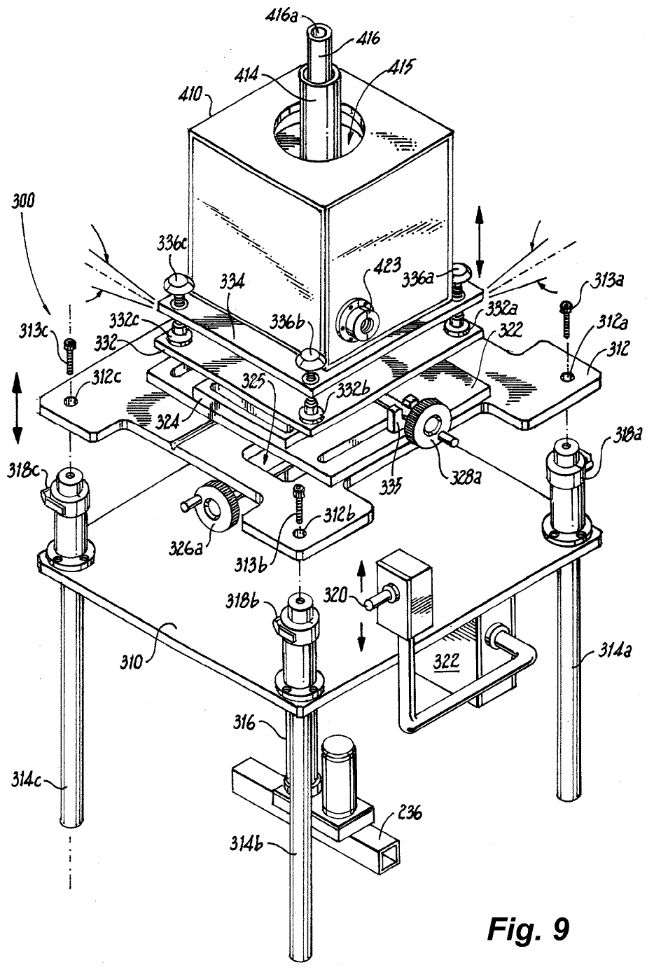

The lift plate 312 is raised and lowered by a centrally located linear actuator 316 that is supported on a bottom rail 236 of the transport cart 200 and it extends upwardly through a central aperture 317 in base plate 310 to connect with a coupling 315 that extends downwardly from the lower surface of lift plate 312, as best seen in FIG. 9. The motorized linear actuator 316 is controlled by a manually operated Z-axis joystick 320 that is mounted in the staging area 212 of the transport cart 200 adjacent the welding platform 300 and electrically connected to the control box 222. In the alternative, the linear actuator 316 could be hydraulically actuated rather than motorized.

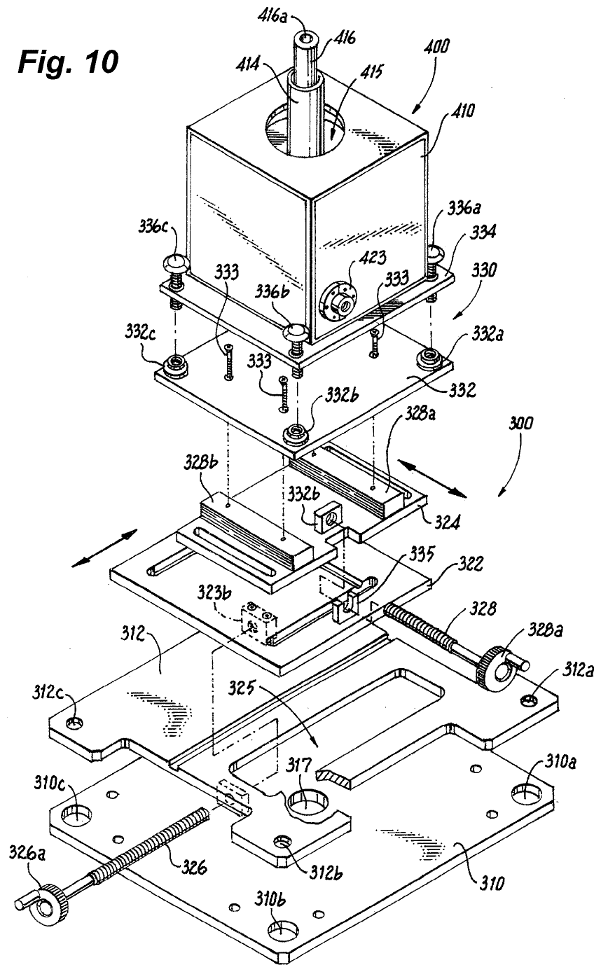

A set of four riser legs 314a-314d extend upwardly from the staging area 212 of frame 210 passing through apertures 310a-310d formed in the base plate 310 (see FIG. 10 and see also the openings in the top of the cart frame 210 shown in FIG. 5 for accommodating respective riser legs). A set of four quick-disconnect clamping collars 318a-318d are fastened to the upper surface of the base plate 310 to cooperate with the four riser legs 314a-314d, respectively. More particularly, as best seen n FIG. 7, each of the four clamping collars 318a-318d, of which clamping collar 318c is shown, includes a compressive sleave 374 that surrounds the riser leg 314c and a manually operated pivotable cam latch 372 for closing the collar sleave 374 around the associated riser leg 314c that extends therethrough.

The riser legs 314a-314d extend and retract relative to the collars 318a-318c on base plate 310 as the lift plate 312 is raised and lowered by the linear actuator 316 relative to the lower base plate 310 along the Z-axis to approximate the riser 10 and pulled collar 12. The clamping collars 318a-318d function as linear guides for the riser legs 314a-314d and mechanical stops for the lift plate 312, supporting vertical loads and preventing lift plate slippage during a welding operation.

The multi-axis welding platform 300 further includes a lower slide plate 322 and an upper slide plate 324 that are adapted and configured to facilitate the axial alignment of the riser 10 relative to the pulled collar 12 of the manifold runner 14. More particularly, the lower slide plate 322 is manually adjustable within a first horizontal plane relative to the lift plate 312 along a first horizontal axis (an X-axis), and the upper slide plate 324 is manually adjustable within a second horizontal plane relative to the lower slide plate 322 along a second horizontal axis (a Y-axis) that is perpendicular to the first horizontal axis.

A first manually adjustable horizontal drive screw 326 is provided for moving the lower slide plate 322 relative to the lift plate 312 within the horizontal plane and along the horizontal X-axis. The drive screw 326 has a knurled handle portion 326a for an operator to grasp and rotate. Drive screw 326 is supported for axial rotation by a threaded flange 323a that extends downwardly from a bottom surface of the lift plate 312, and it is operatively associated with a threaded flange 323b that extends downwardly from the bottom surface of the lower slide plate 322. In use, axial rotation of drive screw 326 causes the linear translation of the lower slide plate 322 along the X-axis. A rectangular slot 325 is formed in lift plate 312 to accommodate the relative movement of the threaded flange 323b when the drive screw 326 in manually operated by a user.

A second manually adjustable horizontal drive screw 328 is provided for moving the upper slide plate 324 relative to the lower slide plate lift plate 322 within the second horizontal plane along the horizontal Y-axis. The drive screw 328 has a knurled handle portion 328a for grasping and rotating. Drive screw 328 is supported for axial rotation by a threaded flange 335 that extends upwardly from the top surface of the lower slide plate 322, and it is operatively associated with a threaded flange 332b that extends upwardly from the top surface of the upper slide plate 324. In use, axial rotation of drive screw 328 causes the linear translation of the upper slide plate 324 along the Y-axis. Parallel stand-off struts 328a and 328b are provided on the top surface of the upper slide plate 324 to provide a clearance space for drive screw 328 and to provide mounting surfaces for the tilt stage assembly 330.

The tilt stage assembly 330 is adapted and configured to provide relative angular positioning of the riser 10 relative to the pulled collar 12 of the manifold runner 14, to ensure that end surface of the two components to be welded together are in co-planar abutment with one another. The tilt stage assembly 330 includes a lower horizontal tilt plate 332 that is fastened to the stand-off struts 328a and 328b by threaded fasteners 333 and an upper tilt plate 334 that is manually adjustable within a tilt plane relative to the horizontal plane defined by the lower tilt plate 332.

More particularly, four corner-positioned threaded vertical leveling rods 336a-336d extend operatively through the upper tilt plate 334 and are operatively associated with respective threaded lugs 332a-332d that are positioned on the lower tilt plate 332 for manually adjusting the angular orientation of the upper tilt plate 334 relative to the horizontal plane defined by the lower tilt plate 332. The relative height of each leveling rod can be independently adjusted to orient the upper lift plate 334 within the tilt plane. This enables the operator to concentrically align the butt-seam and ensure that a constant weld gap can be maintained.

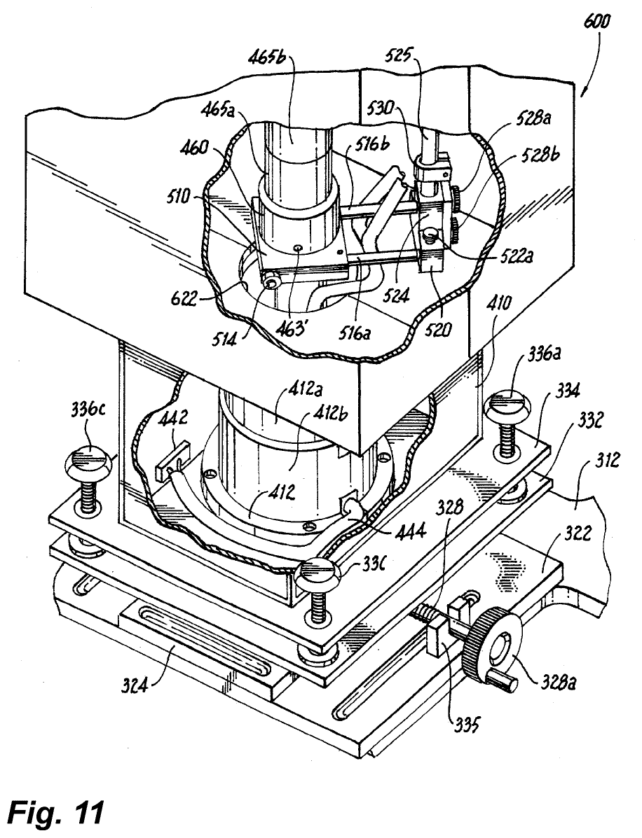

Referring now to FIGS. 11 through 13 and 17, the orbital weld head assembly 400 of the welding system 100 is supported on the upper tilt plate 334 of the multi-axis welding platform 300. The orbital weld head assembly 400 includes a rectangular enclosure 410 that contains a shaft housing 412. The shaft housing 412 includes a main body portion 412a and a lower base portion 412b that supports a slip ring assembly that allows for the transmission of power from the shaft housing 412 to a rotating electrode shaft 414.

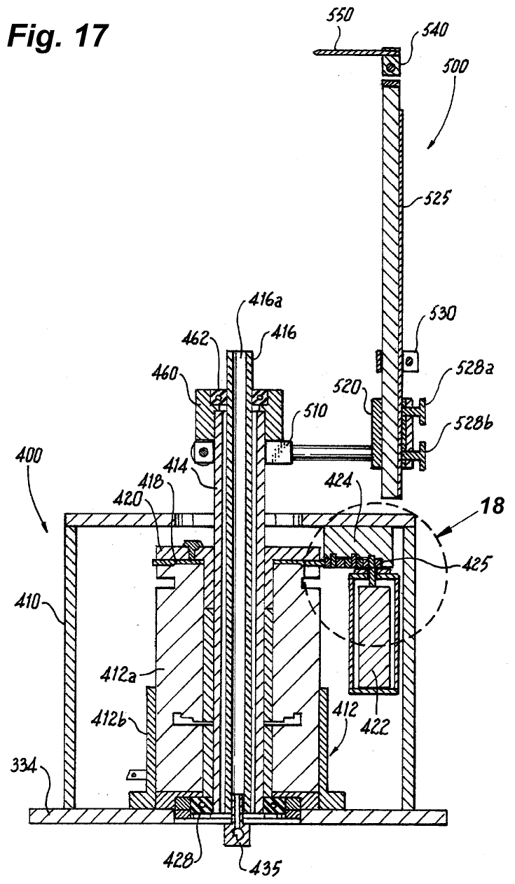

The shaft housing 412 of the weld head assembly 400 supports a radially outer rotating electrode shaft 414 and a radially inner non-rotating insulated shaft 416, which are best seen in FIG. 17. A central aperture 415 in the top wall of the enclosure 410 accommodates passage of the upper end portions of the two co-axial shafts 414 and 416. The lower end portion of the outer electrode shaft 414 is supported for rotation by a ring bearing 428 that is seated in the upper tilt plate 334 at the bottom of enclosure 410. As will be explained in more detail below, the outer electrode shaft 414 is mechanically and electrically connected to the torch assembly 500, and it rotates relative to the inner insulated shaft 416, which communicates with the riser 10.

A drive gear 418 is mounted coaxially with and operatively connected to the outer rotating shaft 414 by way of a slip ring 420, so that rotation of the drive gear 418 causes the direct rotation of the slip ring 420 along with the outer shaft 414. The slip ring 420 allows for the transmission of power from the shaft housing 412 to the rotating electrode shaft 414. A servo motor 422 is mounted within the main enclosure 410 of the weld head assembly 400 and it is operatively connected to the drive gear 418 by way of a gear box 424. A cable harness connection 423 (see FIG. 9) is provided on the exterior of the enclosure 410 to connect the servo motor 422 to a power cable from the control box 222 on the transport cart 200.

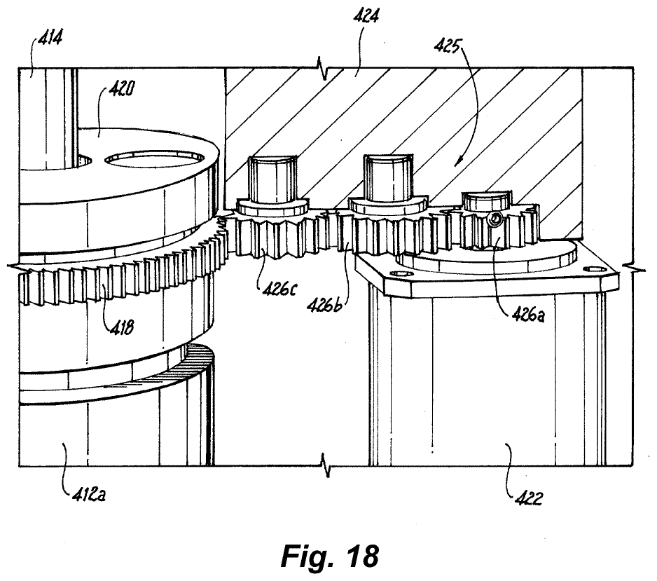

As best seen in FIG. 18, the gear box 424 contains a gear train 425 that includes three intermeshed spur gears, namely, a driving spur gear 426a, an intermediate spur gear 426b and a driving spur gear 426c that meshes with the drive gear 418. Upon activation of the servo motor 422, the gear train 425 transfers torque to the drive gear 418 which in turn rotates the electrode shaft 414 about a vertical axis relative to the insulated non-rotating shaft 416.

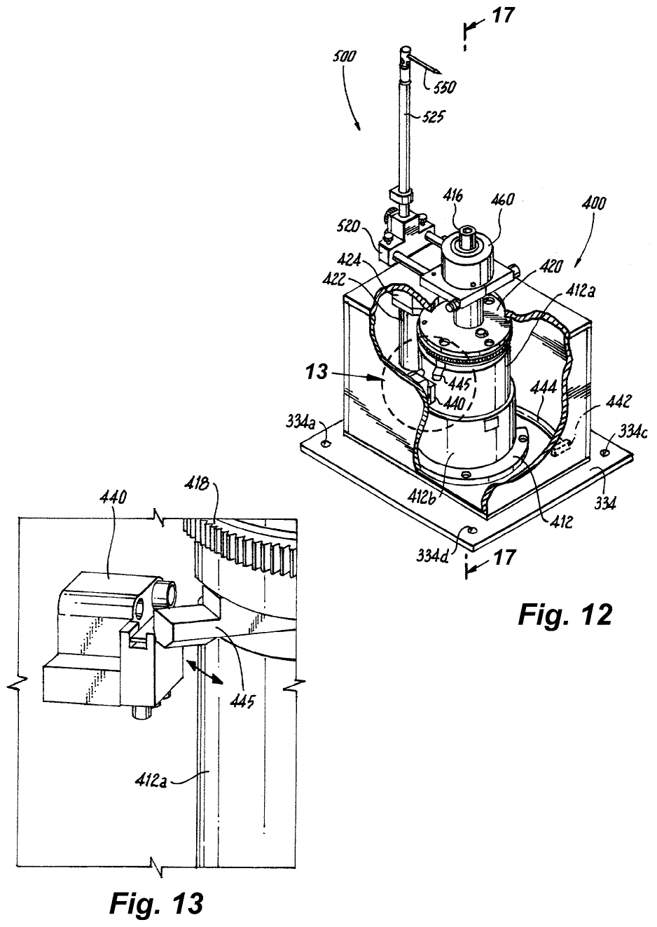

Referring to FIGS. 12 and 13, a limit switch assembly 440 is provided within the enclosure 410 of the weld head assembly 400 and it is operatively associated with slip ring 420 for detecting the position of the drive gear 418, and to detect when the weld head assembly 400 returns to its home position after each weld cycle. More particularly, a contact flange 445 is mounted to rotate with the slip ring 420 and interact with the limit switch 440. A trimmer potentiometer 442 is provided in the enclosure 410 and it is wired to the lower portion the shaft housing 412 by way of cable 444 for adjusting, tuning, and calibrating the powered components of the weld head assembly 400. As illustrated in FIGS. 1-3, a weld head ground cable 350 is operatively associated with the weld head assembly 400 for connecting to the manifold runner 14 during the welding procedure.

With continuing reference to FIG. 17, the non-rotating insulated inner shaft 416 has an axial bore 416a extending therethrough to provide a pathway for purge gas released from the manifold runner 14 after the welding operation. More particularly, as best seen FIG. 21, purge gas from the manifold runner 14 travels through the axial bore 416a of the non-rotating shaft 416 to an outlet fitting 435 that is located below the upper tilt plate 334. The purge gas could be vented directly from the outlet fitting 435 or directed away from the enclosure 400 by way of a conduit connected to the outlet fitting 435.

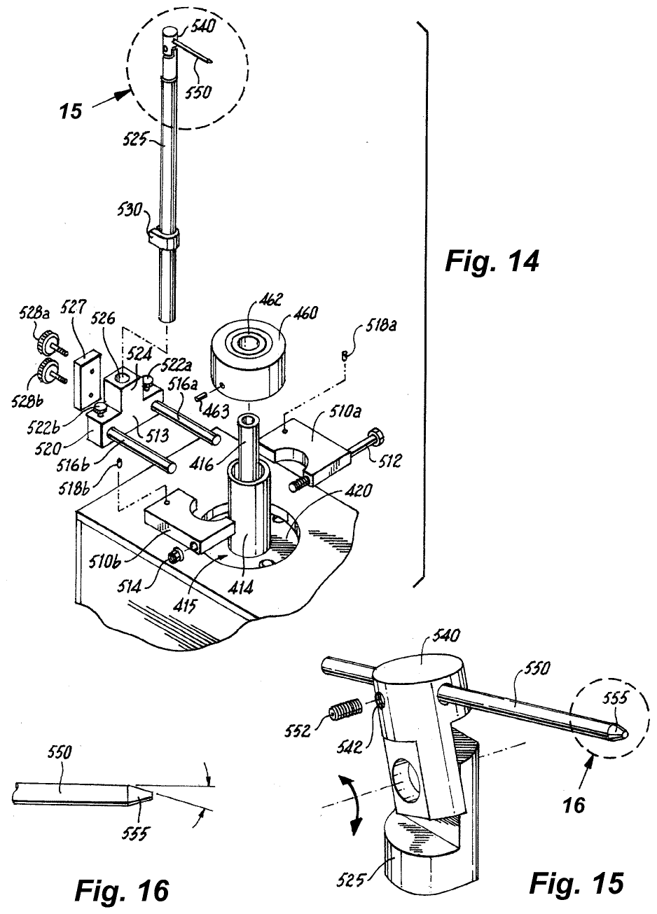

Referring now to FIGS. 11, 12 and 14-17, seated at the upper end portion of the outer electrode shaft 414 is a bearing housing 460. The bearing housing 460 is secured to the outer electrode shaft by a threaded set screw 463, best seen in FIG. 14. An upper ring bearing 462 is seated in bearing housing 460 to support the axial rotation of the outer shaft 414 relative to the non-rotating inner insulating shaft 416. The inner insulating shaft 416 extends upwardly beyond the top of the bearing housing 460 and it defines a fixturing connection for a riser 10 or for one or more spacers 465a, 465b upon which a riser may be supported for welding, as shown for example in FIG. 11.

With continuing reference to FIGS. 12, 14 and 17, the torch assembly 500 of the orbital welding system 100 is operatively connected to the rotating electrode shaft 414 below the bearing housing 460 by a coupling assembly 510. The coupling assembly 510 includes a pair of opposed horizontal coupling plates 510a, 510b that surround the outer electrode shaft 414. The two coupling plates 510a, 510b are secured to one another and compressed together around the outer shaft 414 by an elongated threaded bolt 512 and nut 514. Once the coupling plates 510a, 510b are secured to one another, the entire coupling assembly 510 will rotate together with the outer electrode shaft 414 about its longitudinal axis, driven by the servo motor 422, gear train 425 and drive gear 418.

The coupling assembly 510 further includes a dual-slide mechanism for vertically and horizontally positioning the tungsten electrode 550 of the torch assembly 500 relative to the butt-seam between the riser 10 and the pulled collar 12 of the manifold runner 14. The mechanism includes a pair of parallel slide rods 516a, 516b that extend from side surfaces of the coupling plates 510a, 510b, opposite the threaded bolt 512. As best seen in FIG. 14, a pair of threaded set screws 518a, 518b secure the slide rods 516a, 516b to the coupling plates 510a, 510b, respectively, preventing the angular and axial movement of the rods relative to the coupling plates.

An inverted T-shaped slide flange 520 is mounted on the pair of parallel slide rods 516a, 516b and it is adapted to slide back and forth relative to the rods within a horizontal plane. A pair of vertical securement screws 522a, 522b are supported in the base portion 523 of the slide flange 520 to interact with the parallel rods 516a, 516b and selectively secure the slide flange 520 in a desired horizontal position along the length of the two slide rods 516a, 516b.

A central flange portion 524 of slide flange 520 extends upwardly from the base portion 513 and it defines a vertical bore 526 for accommodating an elongated conductive torch head shaft 525. More particularly, the torch head shaft 525 is mounted in such a manner so that it can be vertically moved up and down relative to the slide flange 520 to adjust its height within the weld zone. More particularly, the torch shaft 525 can be selectively secured in a desired vertical position by a pair of horizontal securement screws 528a, 528b that are associated with the slide flange 510 by way of an apertured plate 527. An adjustable abutment ring 530 can be selectively positioned along the length of the torch shaft 525 to serve as an electrical interface between the weld head enclosure 410 and the torch shaft 525, providing a connection point for the two cables shown adjacent to the torch shaft 525 in FIG. 11.

An electrode holder 540 is connected to an upper end of the torch head shaft 525 for retaining the non-consumable tungsten electrode 550. The electrode holder 540 is hingedly connected to an upper end portion of the torch shaft 525 and it is angularly adjustable relative to the torch shaft 525 about a horizontal hinge axis that extends perpendicular to the elongated axis of the torch shaft 525, as best seen in FIG. 15. Movement of the electrode holder 540 about the hinge axis allows the user to accurately position the tapered distal end portion 555 of the electrode 550 (see FIG. 16) relative to the butt-seam to be welded. A threaded set screw 552 is provided for selectively securing the proximal portion the tungsten electrode 550 within a mounting bore 542 of the electrode holder 540.

Referring now to FIGS. 1 through 4, 8 and 11, the weld shield assembly 600 of orbital welding system 100 encloses the torch assembly 500 and defines a welding chamber. An inert shielding gas, such as argon, is fed into the chamber defined by the weld shield assembly 600 to protect the weld zone from atmospheric contamination. More particularly, the inert gas protects the tungsten electrode 550 and the heat-affected weld zone from contamination by atmospheric elements. If the weld area and tungsten electrode are not shielded properly, atmospheric elements can be absorbed and contaminate the weld, causing the weld area to become brittle and porous.

As illustrated in FIGS. 1 and 2, an oxygen analyzer 650 monitors purge gas purity at the weld shield assembly 600 or at the manifold runner 14. More particularly, the oxygen analyzer is configured to detect any atmospheric contaminants displaced by the inert gas, whether measured at the weld shield housing 610 or from a port associated with the manifold runner 14 (e.g., from the port 15a on end cap 14a, shown in FIG. 1).

The weld shield assembly 600 is constructed from a pair of opposed rectangular shield sections 610a, 610b that are secured to one another by one or more locking clasp mechanisms 612, one of which is shown in FIG. 4. Each of the one or more locking clasp 612 include a D-ring portion 612a supported on one of the two shield sections (e.g., shield section 610a), a hook portion 612b supported on the other of the two shield sections (e.g. shield section 610b), and a closure tab 612c which enables a user to manually engage/disengage the D-ring portion 612a with the hook portion 612b.

Referring to FIGS. 8 and 11, an aperture 622 in the floor of the weld shield 600 is dimensioned to accommodate the passage of the outer and inner rotating shafts 414, 416 and related power cables into the enclosure. Moreover, the aperture 622 permits the displacement of oxygen by the purge gas during the welding procedures, and the egress of purge gas from the weld shield housing 610 at the conclusion of the welding procedure. Viewing windows 614a, 614b with weld lenses are provided in shield sections 610a, 610b, respectively, for safely allowing an operator to safely observe the welding process.

With continuing reference to FIG. 8, the opposed lateral side walls of the shield sections 610a, 610b each have circular portals 616a, 616b for accommodating the manifold runner 14. The circular portals 616a, 616b are horizontally aligned and configured to receive manifold runner inserts 620a-620c of differing size for accommodating runners of varying outer diameter. The welding system 100 can include a kit containing a set of runner inserts (e.g., 620a-620c) that are sized to accommodate manifold runners having outer diameters in the range of 0.50 inches to 4.00 inches.

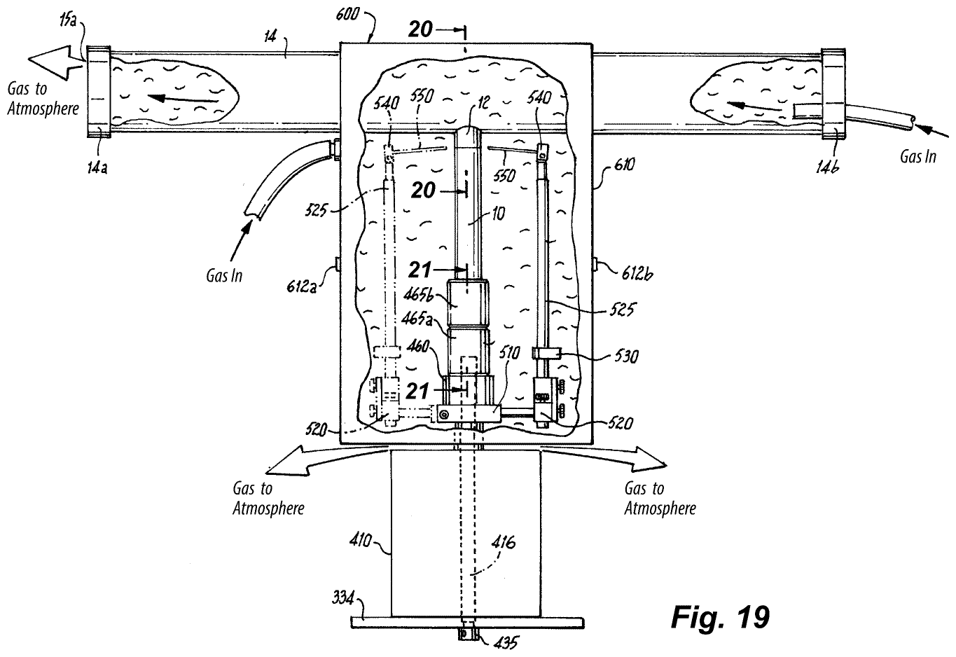

Referring now to FIGS. 19, during a welding procedure in which a tubular riser 10 is butt-welded to a pulled collar 12 of a manifold pipe or tube runner 14, the position of the tubular riser 10 is adjusted relative to the manifold pipe or tube runner 14 by way of the muti-axis welding platform 300, and the position of the tungsten electrode 550 is adjusted relative to the butt-seam by way of the dual-slide mechanism 520 and hinged electrode holder 540 of the torch assembly 500, so it is aligned with the butt-seam between the riser 10 and pulled collar 12.

Thereafter, inert purge gas such as argon, sourced from a centralized location within the manufacturing facility or workshop, is introduced into the inner diameter of riser 12 and the manifold runner 14, and inert purge gas is also introduced into the weld shield enclosure 610 by way of the instrument panel 216 on the transport cart 200. More particularly, the gas is routed through a main supply valve (not shown) and directed to the instrument panel 216 on transport cart 200. Within the instrument panel 216, the gas passes through the following components in series: a diaphragm valve that serves as a primary supply shut-off valve; a pressure regulator that controls and stabilizes the incoming gas pressure, the filter housing 224 to remove particulates and moisture from the gas so as to protect downstream components; and a gas purifier (not shown) to ensure high-purity argon for optimal shielding performance.

After purification, the gas is distributed by way of flowmeters 218a, 218b to two key destinations: the inlet cap 14b on the manifold runner 14 and the housing 610 of the weld shield assembly 600 as shown in FIGS. 1 and 19. The weld shield housing 610 is intentionally designed to be non-airtight, allowing oxygen to be displaced naturally as the argon purge gas fills the space. This design eliminates the need for a dedicated vent or outlet port on the weld shield housing 610. Although, at the conclusion of the welding process, the purge gas is routed out of the weld shield housing 610 through the lower opening 622, as explained in more detail below.

To monitor system performance, the magnehelic gauge 220 on the instrument panel 216 measures differential pressure based on input from a weld shield gas return line (not shown) and from the manifold runner outlet port in vent cap 14a. The oxygen analyzer 650 shown in FIGS. 1 and 2, may be installed at either the weld shield housing 610 as shown or at a poet 15b in the manifold runner vent cap 14a to verify purge gas purity. Both locations are suitable for monitoring.

Those skilled in the art will readily appreciate that the purge gas serves to protect the butt-weld from atmospheric contamination as the tungsten electrode 550 rotates and generates an electric arc that melts the steel material and forms the weld, as shown in FIG. 20.

At the conclusion of the welding procedure, the inert purge gas leaves the interior of the riser 10 and manifold runner 14 through the interior bore of the non-rotating insulated inner shaft 414, as shown in FIG. 21. Alternatively, or in addition to that exit path, purge gas can leave the manifold runner 14 through a vent port 15a in the end cap 14a. Concurrently, as illustrated in FIG. 19, purge gas exits from the weld shield housing 610 through the opening 622 in the floor of the weld shield housing 610, and from there it flows to atmosphere between a gap that exists between the floor of housing 610 and the top wall of housing 410, so that a majority of the purge gas will not enter the housing 410 through the central aperture 415 in the top wall thereof.

Referring now to FIG. 22, while the orbital welding system 100 of the subject disclosure is advantageously supported on a transport cart 200 so that it can be readily transported from one location to another throughout a manufacturing facility, it is envisioned and well within the scope of the subject disclosure that the multi-axis welding platform 300, together with the weld head assembly 400, torch assembly 500 and weld shield assembly 600 can be readily removed from the transport cart 200 and mounted on a separate stationary weld bench or fixturing stand 700, as disclosed for example in commonly assigned U.S. patent application Ser. No. 19/244,342, which is incorporated herein by reference in its entirety. More particularly, the welding platform 300 is mounted on a support structure 710 that is movably supported on a horizontal track assembly 720 that permits movement of the welding system (300, 400, 500, 600) along a horizontal axis, so that the welding system can be readily positioned at one or more locations along the length of the fixturing stand 700.

Those skilled in the art will readily appreciate that when the welding platform 300 is removed from the transport cart 200 and mounted on support structure 710, purge gas would be supplied to the weld shield 600 and the interior of a manifold runner extending therethrough by way of a gas source associated with the weld bench 700. Furthermore, the programmable solid state power supply unit 730 located adjacent to the weld bench 700 would deliver power to and control the welding parameters of the weld head assembly 400.

While the mobile close-proximity orbital welding system and method of the subject invention has been shown and described with reference to preferred embodiments, those skilled in the art will readily appreciate that changes and/or modifications may be made thereto without departing from the spirt or scope of this disclosure.

What is claimed is:

1. An orbital welding system for joining a riser to a pulled collar on a manifold runner with a circumferential weld bead, comprising:
a) a multi-axis welding platform including a base plate defining a horizontal plane, a lift plate adjustable along a vertical axis relative to the base plate, a lower slide plate adjustable within a first horizontal plane relative to the lift plate along a first horizontal axis, an upper slide plate adjustable within a second horizontal plane relative to the lower slide plate along a second horizontal axis that is perpendicular to the first horizontal axis, and a tilt stage assembly including a lower tilt plate defining a third horizontal plane and an upper tilt plate that is adjustable within a tilt plane relative to the lower tilt plate;
b) a weld head assembly supported on the upper tilt plate of the tilt stage assembly of the multi-axis welding platform and including a shaft housing, an elongated radially outer electrode drive shaft mounted for axial rotation within the shaft housing, a drive motor operatively connected to the electrode drive shaft for axially rotating the electrode drive shaft relative to the shaft housing, and an elongated non-rotating radially inner insulated support shaft extending coaxially through an axial bore of the outer drive shaft; and
c) a torch assembly including a dual-axis slide mechanism coupled to an upper end portion of the electrode drive shaft so that the torch assembly rotates coaxially with the electrode drive shaft, an elongated vertical torch shaft extending from the dual-axis side mechanism, and an electrode holder connected to an upper end portion of the vertical torch shaft for retaining a tungsten electrode.

2. An orbital welding system as recited in claim 1, further comprising a mobile transport cart including a rectangular structural frame and defining an upper staging area for supporting the base plate multi-axis welding platform.

3. An orbital welding system as recited in claim 2, wherein the mobile transport cart further includes a plurality of castor assemblies each including a swiveling support bracket mounted to the structural frame, a rotatable castor wheel mounted to the bracket, a pivoting wheel lock lever for securing the position of the castor wheel to maintain the transport cart in a fixed position and a stabilizing foot for leveling the transport cart.

4. An orbital welding system as recited in claim 1, wherein a linear actuator extends through an aperture in the base plate of the multi-axis welding platform and is operatively connected to a bottom surface of the lift plate for moving the lift plate along the vertical axis relative to the base plate.

5. An orbital welding system as recited in claim 1, wherein a plurality of vertical riser legs extend upwardly through respective apertures in the base plate and an upper end of each riser leg is fastened to a bottom surface of the lift plate to vertically support the lift plate.

6. An orbital welding system as recited in claim 5, wherein a clamping collar is operatively associated with each riser leg for securing the vertical position of each riser leg relative to the base plate.

7. An orbital welding system as recited in claim 4, wherein a manually operated joystick is operatively associated with the welding platform for controlling the linear actuator.

8. An orbital welding system as recited in claim 1, wherein a first manually adjustable horizontal drive screw is operatively associated with the lower slide plate for moving the lower slide plate within the first horizontal plane relative to the lift plate.

9. An orbital welding system as recited in claim 1, wherein a second manually adjustable horizontal drive screw is operatively associated with the upper slide plate for moving the upper slide plate within the second horizontal plane relative to the lower slide plate lift plate.

10. An orbital welding system as recited in claim 1, wherein a plurality of manually adjustable vertical leveling rods is operatively associated with the tilt stage assembly for angularly moving the upper tilt stage plate within the tilt plane relative to the lower tilt stage plate.

11. An orbital welding system as recited in claim 1, wherein a drive gear is coaxially mounted to the electrode drive shaft by a securement hub, and wherein the drive gear is operatively connected to a servo motor by a spur gear assembly housed in a gear box.

12. An orbital welding system as recited in claim 11, wherein a limit switch is operatively associated with the drive gear and/or the slip ring for detecting the rotational position of the drive gear and/or the slip ring and to detect when the weld head assembly returns to a home position after a weld cycle.

13. An orbital welding system as recited in claim 1, wherein a bearing housing is operatively connected to an end upper portion of the outer drive shaft by a threaded set screw, and a ring bearing is seated in the bearing housing to accommodate axial rotation of the outer drive shaft relative to the non-rotating inner support shaft.

14. An orbital welding system as recited in claim 1, wherein an upper end portion of the non-rotating shaft extends above the bearing housing and defines a fixturing connection for accommodating one or more spacers and/or the riser.

15. An orbital welding system as recited in claim 13, wherein the dual-axis slide mechanism is coupled to the upper end portion of the outer drive shaft below the bearing housing so that the torch assembly rotates coaxially with the electrode drive shaft and the bearing housing relative to the inner support shaft.

16. An orbital welding system as recited in claim 15, wherein the dual-axis slide mechanism includes a slide flange that is slidably mounted on a pair of horizontal slide rods, wherein the slide flange has a central flange portion with a vertical bore for accommodating the vertical torch shaft, and wherein the slide flange is adapted to be selectively positioned and retained along the length of the slide rods in a desired horizontal position and is configured for selectively retaining the torch shaft in a desired vertical position.

17. An orbital welding system as recited in claim 16, wherein the electrode holder is pivotably connected to an upper end portion of the vertical torch shaft and is configured for angular adjustment about a horizontal pivot axis extending perpendicular to the torch shaft.

18. An orbital welding system as recited in claim 17, wherein a set screw is provided for securing the tungsten electrode within a retaining bore formed in the electrode holder.

19. An orbital welding system as recited in claim 1, wherein an axial bore extends through the non-rotating support shaft to define a path for the ingress and egress of purge gas from an interior of the manifold runner, and wherein the axial bore of the support shaft communicates with a purge outlet located below the upper tilt plate.

20. An orbital welding system as recited in claim 1, wherein a lower end portion of the outer drive shaft is supported for rotation by a ring bearing seated in the upper tilt plate.

21. An orbital welding system as recited in claim 2, further comprising a weld shield assembly configured to enclose the torch assembly to define a shielded chamber for receiving an inert gas that protects a weld from atmospheric contamination.

22. An orbital welding system as recited in claim 21, wherein the weld shield assembly is constructed from a pair of opposed rectangular shield sections that are releasably secured to one another by one or more locking clasps.

23. An orbital welding system as recited in claim 22, wherein one or both shield sections includes a viewing window with a weld glass for observing a welding process.

24. An orbital welding system as recited in claim 21, further comprising a gas analyzer for monitoring gas purity at the weld shield assembly or at the manifold runner.

25. An orbital welding system as recited in claim 22, wherein the weld shield assembly has opposed lateral side walls each having a circular portal for accommodating passage of the manifold runner, and wherein the circular portals are horizontally aligned and configured to receive runner insert rings of differing size for accommodating runners of varying outer diameter.

26. An orbital welding system as recited in claim 2, further comprising a programmable solid state power supply unit supported on the mobile transport cart adjacent the multi-axis welding platform for controlling welding parameters of the system and delivering power to the weld head assembly.

27. An orbital welding system as recited in claim 21, wherein the mobile transport cart includes an instrument panel containing a flow meter and associated regulating valve for monitoring and regulating gas flow to and from the weld shield assembly, a flow meter and associated regulating valve for monitoring and regulating gas flow to and from the manifold runner, and a magnehelic gauge and associated regulating valve for monitoring and regulating differential pressure across a weld surface between the riser and the pulled collar of the manifold runner.

28. An orbital welding system as recited in claim 27, wherein the mobile transport cart carries a filter housing to accommodate a filter for removing contaminants and/or moisture from the inert gas prior to delivery to the weld shield assembly and the manifold runner.

29. An orbital welding system as recited in claim 1, wherein the weld head assembly is configured for removal from the multi-axis welding platform on the mobile transport cart and mounting on a stationary weld bench.

30. A method of orbital welding comprising the steps of:
a) axially aligning and approximating a riser with a pulled collar of a manifold runner within a shielded enclosure to define a circumferential butt seam therebetween;
b) positioning a tungsten electrode relative to the butt seam within the shielded enclosure;
c) introducing an inert purge gas into an inner diameter of the riser and the manifold runner, and into the shielded enclosure to protect the butt seam from atmospheric contamination while welding;
d) orbitally welding the riser to the pulled collar along the butt seam by rotating the tungsten electrode about a central axis of the riser; and
e) venting the inert purge gas from the manifold runner and the shielded enclosure after welding.

31. A method of orbital welding according to claim 30, further comprising the step of monitoring gas purity at the shieled enclosure and/or at the manifold runner.

32. A method of orbital welding according to claim 30, further comprising the step of monitoring and/or regulating differential pressure across a weld surface of the butt seam.

33. A method of orbital welding according to claim 30, further comprising the step of filtering the purge gas before delivery to the manifold runner and/or the shieled enclosure to remove particulates and moisture from the gas.

34. A method of orbital welding according to claim 33, further comprising the step purifying the filtered purge gas.

35. A method of orbital welding according to claim 30, wherein the riser is axially aligned and approximated with the pulled collar by manually adjusting a multi-axis welding platform supporting the riser.
